(19) United States
(12) Patent Application Publication
(10) Pub. No.: US 2021/0087750 A1
(43) Pub. Date: Mar. 25, 2021

(54) AQUEOUS COATING MATERIAL FOR SYNTHETIC PAPERS AND SYNTHETIC PAPER USING THE SAME

(71) Applicant: NAN YA PLASTICS CORPORATION, Taipei (TW)

(72) Inventors: TE-CHAO LIAO, TAIPEI (TW); SEN-HUANG HSU, TAIPEI (TW); Hsu-Ming Cheng, TAIPEI (TW)

(21) Appl. No.: 17/008,899

(22) Filed: Sep. 1, 2020

(30) Foreign Application Priority Data
Sep. 25, 2019 (TW) 108134533

(51) Int. Cl. D21H 19/58; D21H 19/38; C08L 33/12; C08L 25/08; C08F 220/06; C08F 220/56; C08F 220/18; C08K 3/013; C08K 3/26; C08K 3/30

(52) U.S. Cl. CPC D21H 19/58; C08K 2201/011; C08L 33/12; C08L 25/08; C08F 220/06; C08F 220/56; C08F 220/1804; C08K 3/013; C08K 3/26; C08K 3/30; C08L 2205/20; C08L 2201/52; C08L 2207/53; C08K 2003/265; C08K 2003/3045; C08K 2201/005; D21H 19/385

(57) ABSTRACT

An aqueous coating material for synthetic papers includes 26 wt % to 75 wt % of an acrylic emulsion, 2 wt % to 10 wt % of hollow latex microspheres and 26 wt % to 70 wt % of an inorganic ink-absorbing material. Each of the hollow latex microspheres has a particle size between 500 nm and 1100 nm, and includes a hollow core, a buffering layer covering the hollow core, and a shell covering the buffering layer. The aqueous coating material can be applied onto a surface of a synthetic paper substrate and formed into a surface coating layer.

### CROSS-REFERENCE TO RELATED PATENT APPLICATION

This application claims the benefit of priority to Taiwan Patent Application No. 108134533, filed on Sep. 25, 2019. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a coating material for synthetic papers, and more particularly to an aqueous coating material for synthetic papers and a synthetic paper using the same.

### BACKGROUND OF THE DISCLOSURE

Traditional printing substrates are wood pulp papers which have poor water resistance and are easily scratched, and thus they are limited in use. Therefore, Japan Oji-Yuka company provides a polyolefin synthetic paper in place of the wood pulp papers, which consist of a biaxially-stretched polypropylene film (i.e., an intermediate substrate layer) and a uniaxially-stretched polypropylene film containing an inorganic salt fine powder (i.e., a paper surface layer) adhered to or coated onto a surface of the biaxially-stretched polypropylene film. The related technical description is disclosed in Japanese Patent No. JPS4640794 and Japanese Patent Publication Nos. JPS56141339 and JPS56118437. Although such a synthetic paper has a certain degree of water resistance and tear resistance, its absorbing ability to a printed ink is not ideal. The reason is that a plastic surface is difficult to absorb an ink and thus cannot serve as a printing interface.

In order to increase a gravure printability of a synthetic paper, Japanese Patent Publication Nos. JPS5010624 and JPS50161478 disclose a solution coated on a paper surface containing 0.005-0.1 g/m² of one or more acrylic copolymers or polyethyleneimine, which serves as an ink-absorbing material. However, the resulting synthetic paper has low ink drying speed during a printing process and thus has not been widely adapted to writing and printing cultural papers.

Patent No. I487822 owned by Nanya Plastics discloses, in a biaxial stretching process of a polypropylene synthetic paper, forming a synthetic paper substrate with micropores by an irregularly-shaped calcium carbonate filler and applying a coating material of a paper surface layer having a thickness of 10 μm or less to the synthetic paper substrate by a gravure coating wheel. The coating material includes 8-20 wt % of acrylic resin, 20-60 wt % of calcium carbonate, 0.1-5% wt % of clay, 0.1-2 wt % of titanium dioxide, 30-90 wt % of water, and 0-2 wt % of an antistatic agent. The resulting synthetic paper has a paper surface with a number of fine pores in a tandem arrangement similar to those of natural paper products. However, the paper surface of the synthetic paper is prone to water absorption which may cause a wet expansion of a coating layer, thus causing the synthetic paper to easily stick to itself and become difficult to be peeled from another synthetic paper, which can easily damage the paper surface. The reason of the wet expansion of the coating layer is that the aqueous acrylic resin has hydrophilic groups whose function is to promote the stabilization of the acrylic resin dispersed in water. However, the hydrophilic groups cause a reduced water resistance of the acrylic resin, and thus the paper surface of the synthetic paper has poor water resistance and may produce debris when wiped with alcohol.

Chinese Patent Publication No. CN102848768A mentions that aziridine can be added as a crosslinking agent to a surface treatment agent to increase coating integrity. Accordingly, the resulting synthetic paper cannot produce debris when printing, and therefore improve the printing stability. However, the acrylic resin has poor ink-absorbing ability and is difficult to be infiltrated, and thus the color saturation of the synthetic paper is poor.

In addition, a conventional solvent-based coating material emits a large amount of solvents into the atmosphere during manufacturing and processing. This not only causes serious environmental pollution, but also increases the greenhouse effect.

### SUMMARY OF THE DISCLOSURE

In response to the above-referenced technical inadequacies, the present disclosure provides an aqueous coating material capable of reducing the emissions of volatile organic compounds (VOCs) and can be formed into a surface coating layer that can increase ink printability and color vividness; and provides a synthetic paper using the aqueous coating material.

In one aspect, the present disclosure provides an aqueous coating material for synthetic papers, which is adapted to be formed into a surface coating layer. The aqueous coating material includes 26 wt % to 75 wt % of an acrylic emulsion, 2 wt % to 10 wt % of hollow latex microspheres and 26 wt % to 70 wt % of an inorganic ink-absorbing material. Each of the hollow latex microspheres has a particle size between 500 nm and 1100 nm, and includes a hollow core, a buffering layer covering the hollow core, and a shell covering the buffering layer.

In certain embodiments, the acrylic emulsion includes at least one self-crosslinking monomer that is selected from acrylate polymers, hydrophobic (meth)acrylates containing alkyl groups, hydrophobic monomers containing styrene groups, (meth)acrylates containing carboxyl groups, diacetone acrylamide, and adipic acid dihydrazide.

In certain embodiments, the acrylic emulsion includes the following self-crosslinking monomers in predetermined amounts:

45 wt % to 75 wt % of one or more acrylate polymers;
0.1 wt % to 10 wt % of one or more hydrophobic (meth)acrylates containing alkyl groups;
10 wt % to 45 wt % of one or more hydrophobic monomers containing styrene groups;
1 wt % to 20 wt % of one or more (meth)acrylates containing carboxyl groups;
2 wt % to 10 wt % of diacetone acrylamide; and
2 wt % to 10 wt % of adipic acid dihydrazide.

In certain embodiments, the glass transition temperatures of the acrylate polymers are between 12° C. to 130° C.

In certain embodiments, the inorganic ink-absorbing material is in the form of particles having an average particle size between 200 nm and 1500 nm.

In certain embodiments, the inorganic ink-absorbing material is at least one selected from calcium carbonate and barium sulfate.

In certain embodiments, the inorganic ink-absorbing material includes calcium carbonate and barium sulfate in a weight ratio of 1:2.5-5.

In certain embodiments, the surface coating layer has a surface roughness Ra between 0.1 and 1.5.

In another aspect, the present disclosure provides a synthetic paper that includes a synthetic paper substrate and a surface coating layer formed on a surface of the synthetic paper substrate. The surface coating layer is formed by the aqueous coating material as mentioned above. The thickness of the synthetic paper substrate is between 8 μm and 100 μm, and the thickness of the surface coating layer is between 1 μm and 10 μm.

One of the advantages of the present disclosure is that the aqueous coating material for synthetic papers can allow a printed ink pattern to have high color saturation and the effects of clearness and color retention and provides properties such as high whiteness and brightness, high opacity, and good ink absorbing ability and water resistance, which are required for applications of the synthetic papers. The technical features of “the acrylic emulsion, the hollow latex microspheres and the inorganic ink-absorbing material are added in predetermined amounts, in which each of the hollow latex microspheres has a particle size between 500 nm and 1100 nm and includes a hollow core, a buffering layer covering the hollow core, and a shell covering the buffering layer” can be used to achieve the mentioned above advantages.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of a synthetic paper of the present disclosure.

FIG. 2 is an enlarged view taken from section II of FIG. 1.

FIG. 3 is a schematic view of a hollow latex microsphere of an aqueous coating material of the present disclosure for synthetic papers.

FIG. 4 is a flowchart of a method for manufacturing the hollow latex microspheres of the aqueous coating material of the present disclosure for synthetic papers.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

Synthetic papers have a very wide range of application at least including paper labels and advertising papers. Therefore, the present disclosure provides an aqueous coating material for synthetic papers, which is configured to provide the properties required for the applications of the synthetic papers, for example, high whiteness and brightness, high opacity, good ink absorbing ability and water resistance. The aqueous coating material of the present disclosure uses an aqueous system including 26 wt % to 75 wt % of an acrylic emulsion, 2 wt % to 10 wt % of hollow latex microspheres and 26 wt % to 70 wt % of an inorganic ink-absorbing material. In certain embodiments, the aqueous coating material of the present disclosure includes an amount of water, for example, 2.5 wt % to 5 wt %, but it is not limited thereto.

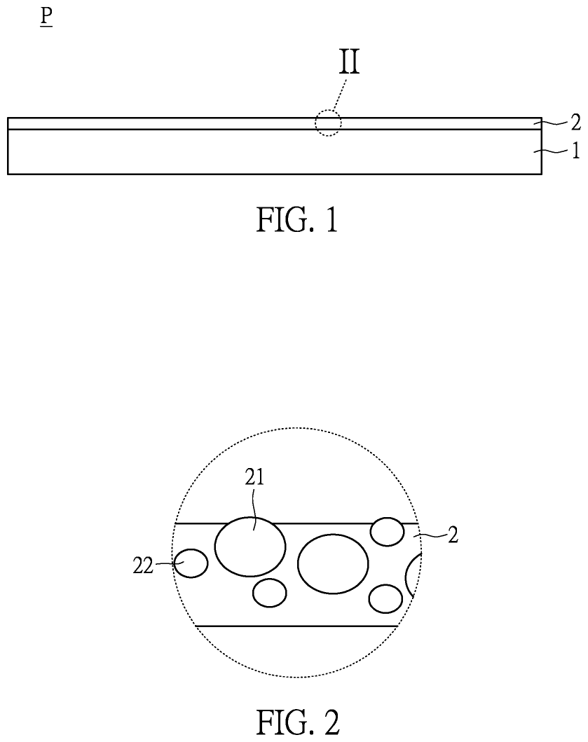

Referring to FIG. 1, in use, the aqueous coating material of the present disclosure can be coated onto a surface of a synthetic paper substrate 1 and be heat-treated at a suitable temperature. Accordingly, the aqueous coating material is cured and formed into a surface coating layer 2. According to actual requirements, the resulting synthetic paper P can be post-processed (e.g., biaxially stretched) to have desired mechanical properties. In certain embodiments, the content of the acrylic emulsion may be 30 wt %, 35 wt %, 40 wt %, 45 wt %, 50 wt %, 55 wt %, 60 wt %, 65 wt % or 70 wt %. The content of the hollow latex microspheres may be 4 wt %, 5 wt %, 6 wt %, 7 wt %, 8 wt % or 9 wt %. The content of the acrylic emulsion may be 30 wt %, 35 wt %, 40 wt %, 45 wt %, 50 wt %, 55 wt %, 60 wt % or 65 wt %.

More specifically, the acrylic emulsion serves as a coating substrate and includes at least one self-crosslinking monomer that is selected from acrylate polymers, hydrophobic (meth)acrylates containing alkyl groups, hydrophobic monomers containing styrene groups, (meth)acrylates containing carboxyl groups, diacetone acrylamide, and adipic acid dihydrazide. Glass transition temperatures of the acrylate polymers are between 12° C. to 130° C. The acrylate polymer can increase the adhesion property between the surface coating layer 2 and the synthetic paper substrate 1. The reason is that, molecular segments may easily migrate into pores of a polymer with low glass transition temperatures (Tg). The pores may be microvoids formed after the polymer is stretched. Specific examples of the acrylic polymer with low Tg include ethyl acrylate, n-propyl acrylate, n-butyl acrylate, isobutyl acrylate and isooctyl acrylate.

The hydrophobic (meth)acrylate containing alkyl groups can prevent water vapor from permeating into the surface coating layer 2 and may result in the collapse of the surface coating layer 2. Specific examples of the hydrophobic (meth)acrylate containing alkyl groups include methyl (meth)acrylate (MMA), ethyl acrylate (EA), propyl (meth)acrylate (PMA), n-butyl acrylate (BA), isobutyl (meth)acrylate (IBMA), amyl (meth)acrylate, hexyl (meth)acrylate, heptyl (meth)acrylate, octyl (meth)acrylate, 2-ethylhexyl (meth)acrylate (2-HEMA), n-octyl (meth)acrylate (OMA), isooctyl (meth)acrylate (IOMA), nonyl (meth)acrylate (NMA), decyl (meth)acrylate, lauryl (meth)acrylate (LMA), stearyl (meth)acrylate, methoxyethyl (meth)acrylate (MOEMA), n-butyl methacrylate (n-BMA), 2-ethylhexyl acrylate (2-EHA), ethoxymethyl (meth)acrylate (EOMAA) and diacetone acrylamide (DAAM).

The hydrophobic monomer containing styrene groups can increase the cohesive force and the hydrophobicity of the surface coating layer 2. Specific examples of the hydrophobic monomer containing styrene groups include styrene, methyl styrene and vinyltoluene. The (meth)acrylate containing carboxyl groups can increase the adhesive force of the surface coating layer 2 and can enhance intermolecular forces, such that the mechanical strength of the surface coating layer 2 can be increased. Specific examples of the (meth)acrylate containing carboxyl groups include acrylic acid (AA), methacrylic acid (MAA), maleic acid (MA), fumaric acid (FA), itaconic acid (IA), crotonic acid and maleic anhydride (MAH).

Diacetone acrylamide can be dehydrated and cross-linked to a carboxylic acid hydrazide resulted from a di- or polycarboxylic acid. The carboxylic acid hydrazide is helpful for forming a polymer network structure, such that the water and alcohol resistances of the surface coating layer 2 can be increased.

Furthermore, the hydrazide is also helpful in reducing the stickiness of the surface coating layer 2 and increasing the scratch resistance of the surface coating layer 2. Specific examples of the carboxylic acid hydrazide include carbonic acid dihydrazide, oxalic acid dihydrazide, succinic acid dihydrazide and adipic acid dihydrazide.

In the present embodiment, the acrylic emulsion includes the following self-crosslinking monomers in predetermined amounts:

45 wt % to 75 wt % of one or more acrylate polymers;
0.1 wt % to 10 wt % of one or more hydrophobic (meth)acrylates containing alkyl groups;
10 wt % to 45 wt % of one or more hydrophobic monomers containing styrene groups;
1 wt % to 20 wt % of one or more (meth)acrylates containing carboxyl groups;
2 wt % to 10 wt % of diacetone acrylamide; and
2 wt % to 10 wt % of adipic acid dihydrazide.

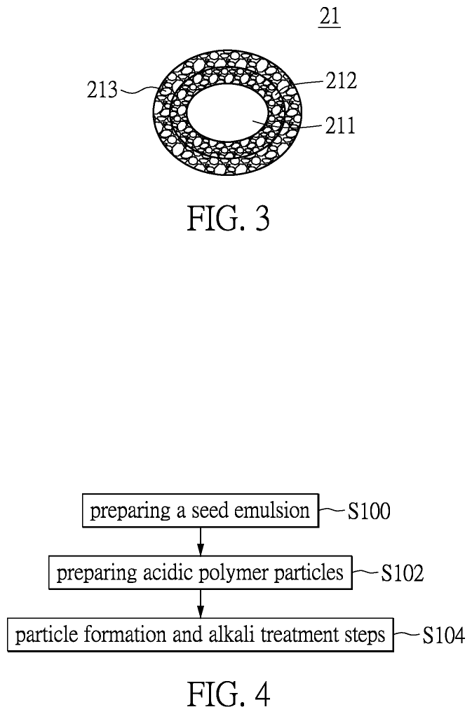

Reference is made to FIG. 1 together with FIG. 2 and FIG. 3, each of the hollow latex microspheres 21 includes a hollow core 211, a porous buffering layer 212 covering the hollow core 211, and a hydrophobic shell 213 covering the buffering layer 212, and preferably has a particle size between 500 nm and 1100 nm. It should be noted that, the hollow latex microspheres 21 have not only excellent water absorption and quick drying properties, but also a complete particle structure that is not easily broken. In use, a printed ink can flow into the hollow core 211 by the capillary phenomenon. In the presence of the hollow latex microspheres 21, the water resistance and printability of the surface coating layer 2 can be increased. Therefore, a resulting ink pattern on the surface coating layer 2 can have high color saturation and the effects of clearness and color retention.

In the present embodiment, the hollow latex microspheres 21 can be prepared by the following steps. The first step (i.e., the step S100) is preparing a seed emulsion, the purpose of which is to provide the foundation of the hollow latex microspheres 21 and to control the particle size and hollowness of the hollow latex microspheres 21. In this step, one or more acrylic monomers, a persulfate as an initiator and an anionic, non-ionic or reactive emulsifier are used for a reaction at a suitable stirring speed for a certain period of time. The details of this step are as follows: methacrylic acid and methyl methacrylate are mixed in the ratio of 1:2; butyl acrylate is added in an amount that is 6-8 times the weight of methyl methacrylate; sodium lauryl sulfate serving as an anionic emulsifier is added in an amount that is 0.5% the weight of the acrylate monomers to carry out a reaction to form the seed emulsion.

In the first step, at least one monomer selected from methyl acrylate, ethyl acrylate, butyl acrylate, ethylhexyl acrylate and methyl methacrylate can be used in place of methyl methacrylate and butyl acrylate.

The second step (i.e., the step S102) is preparing acidic polymer particles. This step is a key step to ensure granularity and integrity of the pores in preparing the hollow latex microspheres 21. In this step, a specific monomer composition and the seed emulsion obtained in the first step are used to carry out an emulsion polymerization reaction. The resulting product includes the acidic polymer particles each having a hollow core 211 and a buffering layer 212 covering the hollow core 211. The buffering layer 212 is a sponge-like structure that facilitates the formation of holes. The details of this step are as follows: the monomer composition includes one or more of acrylates and methyl methacrylates, and its amount is 1-5 times the weight of the seed emulsion; the emulsion polymerization reaction is carried out in the presence of ethylene glycol dimethacrylate, the amount of which is 0.2-3 phr based on 100 phr of the monomer composition; the buffering layer 212 can have a desired thickness between 0.05 nm and 0.1 nm by adjusting the mixture ratio of the monomer composition and the seed emulsion.

The third step (i.e., the step S104) includes particle formation and alkali treatment steps, the purpose of which is to form the hydrophobic shells 213. In this step, one or more hydrophobic vinyl monomers are used to form a coating on each of the acidic polymer particles, and one or more polyfunctional acrylic cross-linking monomers are used to form a cross-linked structure between the core and shell material so as to increase the coating ratio of the hydrophobic monomers. The details of this step are as follows: the product obtained in the second step and styrene monomers are used in a weight ratio of 1:10 to carry out an emulsion polymerization reaction; ammonia is added to the resulting reaction product to form a polymer emulsion that includes a plurality of hollow latex microspheres 21 with uniform particle size and good dispersion.

In the alkali treatment stage, alkali molecules can enter the particles to react with carboxyl groups, such that the particles can continuously expand in volume and finally form into the hollow latex microspheres 21. The alkali treatment is preferably performed at a temperature between 40° C. and 90° C., but is not limited thereto. For example, the alkali treatment can be performed at a temperature higher than the glass transition temperature of a shell polymer, which can provide an inward diffusion energy to the alkali molecules.

Reference is made to FIG. 1 together with FIG. 2. The inorganic ink-absorbing material 22 is helpful for increasing the ink absorbing ability of the surface coating layer 2, and can provide properties such as an increased whiteness and haziness, which are required for applications of synthetic papers. In the present embodiment, the inorganic ink-absorbing material 22 is in the form of particles having an average particle size between 20 nm and 1500 nm, preferably calcium carbonate particles having an average particle size between 1.2 μm and 5 μm. The calcium carbonate particles have the properties of high porosity and high surface area, such that they can be added in a coating material to increase shielding effect and ink absorption speed. It should be noted that the aqueous coating material of the present disclosure, in which the hollow latex microspheres 21, the inorganic ink-absorbing material 22 and the acrylic emulsion are used together, can directly produce the effects of quick ink absorption speed and high color saturation.

If necessary, the aqueous coating material of the present disclosure can include 0.05 wt % to 0.1 wt % of one or more additives that can be at least one selected from a leveling agent, a wetting agent, a defoaming agent, a stabilizer, an antibacterial agent, an antioxidant, a dispersant, a matting agent, an adhesion promoter and a thickener.

Reference is made again to FIG. 1 and FIG. 2, the present disclosure further provides a synthetic paper P that includes a synthetic paper substrate 1 and a surface coating layer 2. The surface coating layer 2 is formed on a surface of the synthetic paper substrate 1. More specifically, the material of the synthetic paper substrate 1 can include polypropylene (PP) and an inorganic filler. The inorganic filler may be at least one selected from silica, titania, zirconia, alumina, aluminum hydroxide, calcium carbonate, magnesium carbonate and barium sulfate. The surface coating layer 2 is formed by an aqueous coating material having the above-mentioned composition. The surface coating layer 2 has a surface roughness Ra between 0.1 and 1.5 in the presence of the hollow latex microspheres 21 having a predetermined particle size and the inorganic ink-absorbing material 22, which are uniformly distributed.

In use, an ink can flow into the hollow core 211 of the hollow latex microspheres 21 through voids among the inorganic ink-absorbing material 22 such as calcium carbonate particles to increase color intensity of a single point, thereby increasing a printed color saturation. In order to increase color saturation by increasing a filling rate of a printed ink, the hollow latex microspheres 21 can have a smaller particle size and be uniformly distributed among the inorganic ink-absorbing material 22 that has a larger particle size, thereby forming an optimal stacked state.

### Preparation of Synthetic Paper

Firstly, water and a crosslinking agent are well mixed with each other. Next, an aqueous acrylic emulsion and both hollow latex microspheres 21 and an inorganic ink-absorbing material 22 are added in and well mixed to form a resulting mixture. Next, the resulting mixture is filtered through a 200 mesh screen to form an aqueous coating material. Lastly, the aqueous coating material is coated onto a surface of a synthetic paper substrate 1 with a coating thickness of 5 μm, and then is dried in a 95° C. oven. The resulting product is tested for physical properties such as coating adhesion property, stickiness, alcohol resistance and scratch resistance.

The synthetic paper P of the present disclosure, when compared to similar products, has obvious improvements, in which the adhesion property, the anti-sticking property, the solvent resistance and the scratch resistance of the surface coating layer 2 are greatly increased. More specifically, acrylic monomers including methyl methacrylate and butyl acrylate have hydrogen bonds that can increase intermolecular force, such that the stability of the surface coating layer 2 and the adhesive strength relative to the inorganic ink-absorbing material 22 are significantly increased. Furthermore, the coating material including a reactive crosslinking agent can be formed into a film with a polymer network structure, such that the water and alcohol resistances of the surface coating layer 2 are significantly increased, thereby solving the problems of stickiness resulted from soaking in water and being easily scratched. In addition, the coating material including the hollow latex microspheres 21 and the inorganic ink-absorbing material 22 can increase ink-absorbing ability so as to increase printing quality.

### Preparation of Ink Absorbing Sphere (i.e., Hollow Latex Microsphere) Containing Emulsion

The ink absorbing sphere containing emulsion is prepared by the following steps. Firstly, 20 g of methacrylic acid (MAA), 40 g of methyl methacrylate (MMA) and 280 g of butyl acrylate (BA) are placed in a bottle with 60 g of deionized water and 1.5 g of sodium dodecyl benzene sulfonate to form a mixed solution (I) by stirring at a high speed. Next, 2000 g of deionized water and 60.4 g of the mixed solution (I) are placed in a reactor, and are heated to 78° C. under stirring. Next, 5 g of ammonium persulfate as an initiator is dissolved by 60 g of deionized water and is placed in the reactor so as to start a reaction. After half an hour, the remaining mixed solution (I) is added dropwise over 1.5 hours into the reactor, and the reaction is continued for 4 hours. Accordingly, an emulsion A having a pH of 2.3, an average particle size of 170 nm and a solid content of 13.5% is obtained.

Next, 175 g of the emulsion A and 1700 g of deionized water are placed in the reactor, and are heated to 80° C. under stirring. Next, 490 g of methacrylic acid, 210 g of methyl methacrylate, 7 g of ethylene glycol dimethacrylate and 3100 g of deionized water are mixed to form a mixed solution (II) by stirring at a high speed. The mixed solution (II) is added dropwise over 3 hours into the reactor, and 8.4 g of ammonium persulfate as an initiator is dissolved by 70 g of deionized water and is added dropwise over 3.5 hours into the reactor to start a reaction. After addition of the mixed solution (II), the reaction is continued at 80° C. for 2 hours. Accordingly, an emulsion B having a pH of 2.3, an average particle size of 324 nm and a solid content of 12.5% is obtained.

Next, 1350 g of the emulsion B and 2200 g of deionized water are placed in the reactor, and are heated to 80° C. under stirring. Next, 1000 g of styrene, 24 g of ethylene glycol dimethacrylate and 3 g of sodium dodecyl sulfate are mixed to form a mixed solution (III) by stirring at a high speed. Next, the mixed solution (III) is added dropwise over 3 hours into the reactor, and 10 g of ammonium persulfate as an initiator is dissolved by 300 g of deionized water and is added dropwise over 3.5 hours into the reactor to start a reaction. After addition of the mixed solution (III), the reaction is continued at 80° C. for 1 hour and then is heated to 90° C. Next, 150 g of 9.5% aqueous ammonia is added and the reaction temperature is lowered to 86° C. and is maintained for 2 hours. Next, the reaction temperature is lowered to room temperature and the resulting condensate is filtered out. Accordingly, the ink absorbing sphere containing emulsion having a pH of 9.5, an average particle size of 856 nm and a solid content of 24.4% is obtained.

### Preparation of Aqueous Acrylic Emulsion

### Preparation Example 1

0.7 g of sodium dodecyl sulfate (SDS) as an emulsifier is added into a reactor with 110 g of deionized water. Next, 30 g of deionized water, 56 g of butyl acrylate (BA), 5 g of methyl methacrylate (MMA), 36 g of styrene (ST), 5 g of acrylic acid (AA), 5 g of SDS (i.e., an emulsifier), 1 g of diacetone acrylamide (DAAM) are mixed to form a mixed solution (IV) by stirring at a high speed. Next, 10 g of the mixed solution (IV) is added into the reactor and is stirred at 76° C., and 10 g of azobisisobutyronitrile (AIBN) as an initiator is dissolved by 10 g of deionized water and is added into the reactor to start a reaction. After 10 minutes, the remaining mixed solution (IV) is added dropwise over 4 hours. After addition of the remaining mixed solution (IV), the reaction is continued for 2 hours. After the completion of the reaction, 0.5 g of adipic acid dihydrazide (ADH) is added, and the resulting product is filtered by a 200 mesh screen to obtain an aqueous acrylic emulsion 1.

### Preparation Example 2

The reaction process is the same as that used in Preparation Example 1 but a different monomer composition is used, which includes 56 g of butyl acrylate, 5 g of methyl methacrylate, 36 g of styrene, 5 g of methacrylic acid (MAA) and 1.5 g of diacetone acrylamide (DAAM). After the completion of the reaction process, 0.75 g of adipic acid dihydrazide (ADH) is added, and the resulting product is filtered by a 200 mesh screen to obtain an aqueous acrylic emulsion 2.

### Preparation Example 3

The reaction process is the same as that used in Preparation Example 1 but a different monomer composition is used, which includes 48 g of butyl acrylate, 10 g of methyl methacrylate, 48 g of styrene, 1 g of acrylic acid (AA) and 2 g of diacetone acrylamide (DAAM). After the completion of the reaction process, 1 g of adipic acid dihydrazide (ADH) is added, and the resulting product is filtered by a 200 mesh screen to obtain an aqueous acrylic emulsion 3.

### Preparation Example 4

The reaction process is the same as that used in Preparation Example 1 but a different monomer composition is used, which includes 70 g of butyl acrylate, 0.15 g of methyl methacrylate, 12 g of styrene, 20 g of acrylic acid (AA) and 2.5 g of diacetone acrylamide (DAAM). After the completion of the reaction process, 1.25 g of adipic acid dihydrazide (ADH) is added, and the resulting product is filtered by a 200 mesh screen to obtain an aqueous acrylic emulsion 4.

### Evaluation Method

The adhesion property is tested by the method as follows. Firstly, a packing tape is applied onto a coating surface. Next, a roller with a weight of 2 kg is used to press against the packing tape. Lastly, the packing tape is quickly peeled from one end thereof to observe whether or not the coating layer is damaged.

The anti-stickiness property is tested by the method as follows. Firstly, the coated synthetic paper is soaked in pure water for 12 hours. Next, two surface areas of the coating surface are attached to each other, and the resulting sample is placed in a 35° C. circulation oven. After the coating surface is completely dried, it is observed whether or not the surface areas have stickiness. In Table 2, “◯” represents the coating surface with stickiness; “X” represents the coating surface without stickiness.

The alcohol resistance is tested by respectively using cotton swabs with different alcohol concentrations (20-95%) to wipe the coating surface of the synthetic paper for ten times. After that, it is observed whether or not the coating layer is damaged or has produced debris, and the highest alcohol concentration that does not damage the coating layer is recorded.

The solvent resistance is tested by using a cotton swab with acetone or degreasing oil to wipe the coating surface of the synthetic paper for ten times. After that, it is observed whether or not the coating layer is damaged or has produced debris, and the results are recorded.

The scratch resistance is tested by the method as follows. Firstly, the coated synthetic paper is soaked in pure water for 1 hour. Next, a piece of sandpaper pressed with a weight of 500 g is used to wipe the coating surface for ten times. After that, it is observed whether or not the coating layer is damaged or has produced debris, and the results are recorded.

The color intensity is evaluated by a TECHKON R410e densitometer that complies with DIN 16536 standard.

### Example 1

As shown in Table 2, 4 g of the ink absorbing sphere emulsion, 40 g of the aqueous acrylic emulsion 1 and 70 g of calcium carbonate are well mixed by stirring, and the resulting mixture is filtered by a 200 mesh screen to obtain a coating material 1. The coating material 1 is applied to a PP synthetic paper by a coating rod and is dried by baking at 95° C. for 15 seconds to form a coating layer having a thickness of 5 μm. A packing tape is used to test the adhesion property of the coating layer which does not fall off. A synthetic paper sample is soaked in pure water for a period of time, and a piece of sandpaper pressed with a weight of 500 g is used to perform the scratch resistance test. The result is that the coating layer does not produce debris. After that, the synthetic paper sample is self-attached and then is dried for the stickiness test. The result is that the synthetic paper sample has no stickiness.

### Example 2

As shown in Table 2, 4 g of the ink absorbing sphere emulsion, 40 g of the aqueous acrylic emulsion 2 and 70 g of calcium carbonate are well mixed by stirring, and the resulting mixture is filtered by a 200 mesh screen to obtain a coating material 2. The coating material 2 is applied to a PP synthetic paper by a coating rod and is dried by baking at 95° C. for 15 seconds to form a coating layer having a thickness of 5 μm. A packing tape is used to test the adhesion property of the coating layer which does not fall off. A synthetic paper sample is soaked in pure water for a period of time, and a piece of sandpaper pressed with a weight of 500 g is used to perform the scratch resistance test. The result is that the coating layer does not produce debris. After that, the synthetic paper sample is self-attached and then is dried for the stickiness test. The result is that the synthetic paper sample has no stickiness.

### Example 3

As shown in Table 2, 5 g of the ink absorbing sphere emulsion, 40 g of the aqueous acrylic emulsion 1 and 70 g of calcium carbonate are well mixed by stirring, and the resulting mixture is filtered by a 200 mesh screen to obtain a coating material 3. The coating material 3 is applied to a PP synthetic paper by a coating rod and is dried by baking at 95° C. for 15 seconds to form a coating layer having a thickness of 5 μm. A packing tape is used to test the adhesion property of the coating layer which does not fall off. A synthetic paper sample is soaked in pure water for a period of time, and a piece of sandpaper pressed with a weight of 500 g is used to perform the scratch resistance test. The result is that the coating layer does not produce debris. After that, the synthetic paper sample is self-attached and then is dried for the stickiness test. The result is that the synthetic paper sample has no stickiness.

### Example 4

As shown in Table 2, 2 g of the ink absorbing sphere emulsion, 70 g of the aqueous acrylic emulsion 3 and 26 g of calcium carbonate are well mixed by stirring, and the resulting mixture is filtered by a 200 mesh screen to obtain a coating material 4. The coating material 4 is applied to a PP synthetic paper by a coating rod and is dried by baking at 95° C. for 15 seconds to form a coating layer having a thickness of 5 μm. A packing tape is used to test the adhesion property of the coating layer which does not fall off. A synthetic paper sample is soaked in pure water for a period of time, and a piece of sandpaper pressed with a weight of 500 g is used to perform the scratch resistance test. The result is that the coating layer does not produce debris. After that, the synthetic paper sample is self-attached and then is dried for the stickiness test. The result is that the synthetic paper sample has no stickiness.

### Comparative Example 1

As shown in Table 2, 40 g of the aqueous acrylic emulsion 1, 70 g of calcium carbonate and 14 g of acrylic hollow spheres are well mixed by stirring, and the resulting mixture is filtered by a 200 mesh screen to obtain a coating material 5. The coating material 5 is applied to a PP synthetic paper by a coating rod and is dried by baking at 95° C. for 15 seconds to form a coating layer having a thickness of 5 μm. A packing tape is used to test the adhesion property of the coating layer which does not fall off. A synthetic paper sample is soaked in pure water for a period of time, and a piece of sandpaper pressed with a weight of 500 g is used to perform the scratch resistance test. The result is that the coating layer does not produce debris. After that, the synthetic paper sample is self-attached and then is dried for the stickiness test. The result is that the synthetic paper sample has stickiness.

### Comparative Example 2

As shown in Table 2, 40 g of the aqueous acrylic emulsion 2, 70 g of calcium carbonate and 14 g of acrylic hollow spheres are well mixed by stirring, and the resulting mixture is filtered by a 200 mesh screen to obtain a coating material 6. The coating material 6 is applied to a PP synthetic paper by a coating rod and is dried by baking at 95° C. for 15 seconds to form a coating layer having a thickness of 5 μm. A packing tape is used to test the adhesion property of the coating layer which does not fall off. A synthetic paper sample is soaked in pure water for a period of time, and a piece of sandpaper pressed with a weight of 500 g is used to perform the scratch resistance test. The result is that the coating layer does not produce debris. After that, the synthetic paper sample is self-attached and then is dried for the stickiness test. The result is that the synthetic paper sample has stickiness.

### Comparative Example 3

As shown in Table 2, 40 g of the aqueous acrylic emulsion 1, 70 g of calcium carbonate and 14 g of acrylic hollow spheres are well mixed by stirring, and the resulting mixture is filtered by a 200 mesh screen to obtain a coating material 7. The coating material 7 is applied to a PP synthetic paper by a coating rod and is dried by baking at 95° C. for 15 seconds to form a coating layer having a thickness of 5 μm. A packing tape is used to test the adhesion property of the coating layer which does not fall off. A synthetic paper sample is soaked in pure water for a period of time, and a piece of sandpaper pressed with a weight of 500 g is used to perform the scratch resistance test. The result is that the coating layer does not produce debris. After that, the synthetic paper sample is self-attached and then is dried for the stickiness test. The result is that the synthetic paper sample has stickiness.

### Comparative Example 4

As shown in Table 2, 40 g of the aqueous acrylic emulsion 1, 70 g of calcium carbonate and 14 g of acrylic hollow spheres are well mixed by stirring, and the resulting mixture is filtered by a 200 mesh screen to obtain a coating material 8. The coating material 8 is applied to a PP synthetic paper by a coating rod and is dried by baking at 95° C. for 15 seconds to form a coating layer having a thickness of 5 μm. A packing tape is used to test the adhesion property of the coating layer which does not fall off. A synthetic paper sample is soaked in pure water for a period of time, and a piece of sandpaper pressed with a weight of 500 g is used to perform the scratch resistance test. The result is that the coating layer does not produce debris. After that, the synthetic paper sample is self-attached and then is dried for the stickiness test. The result is that the synthetic paper sample has stickiness.

In summary, an aqueous acrylic emulsion having carboxylic acid groups has an increased adhesive strength relative to its inorganic ink-absorbing material, and can enhance intermolecular forces to significantly increase the stability of the coating layer.

Furthermore, the coating materials of Examples 1 and 2 each can be formed into a film with a polymer network structure, such that the water and alcohol resistances of the coating layer are significantly increased, thereby solving the problems of stickiness and easily being scratched of the coating layers. However, the crosslinking agent having three carbodiimide groups and three isocyanate groups cannot provide an effective improvement in stickiness property.

The coating material of the present disclosure, in which calcium carbonate, an ink absorbing sphere containing emulsion and an acrylic emulsion are selected and combined according to the best particle size distribution, can allow a printed synthetic paper to have high color intensity and saturation and have a good ink drying ability and a good color durability.

The synthetic paper of the present disclosure compared to similar products has apparent water resistance and an excellent printability, in which the adhesion property, the anti-stickiness property, the solvent resistance and the scratch resistance of the surface coating layer are greatly increased.

TABLE 1
Composition and properties of acrylic emulsion

| | | | Acrylic emulsion | | | |
|---|---|---|---|---|---|---|
| | | Chemicals | 1 | 2 | 3 | 4 |
| Base of reactor | | Deionized | 100 | 100 | 100 | 100 |
| | | water | | | | |
| | | Emulsifier | 0.5 | 0.5 | 0.5 | 0.5 |
| | | (SDS) | | | | |
| Pre- | Pure water | | 30 | 30 | 30 | 30 |
| emulsion | Reactive emulsifier | | 2.0 | 1.0 | 1.0 | 2.0 |
| | Anionic emulsifier | | 1.0 | 2.0 | 1.0 | 2.0 |
| | Non-ionic emulsifier | | 1.0 | 1.0 | 2.0 | — |
| | (a) Acrylate with | BA | 56 | 56 | 46 | 72 |
| | low Tg | | | | | |
| | (b) Methacrylate | MMA | 5.0 | 5.0 | 10 | 0.15 |
| | containing alkyl | | | | | |
| | groups | | | | | |
| | (c) Hydrophobic | ST | 36 | 36 | 46 | 10.2 |
| | monomer | | | | | |
| | containing | | | | | |
| | styrene groups | | | | | |
| | (d) Methacrylate | AA | 5.0 | 0 | 1.0 | 20 |
| | containing | MAA | 0 | 5.0 | 0 | 0 |
| | carboxyl groups | | | | | |
| | (e) Diacetone | DAAM | 1 | 1.5 | 2.0 | 2.5 |
| | acrylamide | | | | | |

| | | | | |
|---|---|---|---|---|
| ADH added after completion | 0.5 | 0.75 | 1.0 | 1.25 |
| of the reaction | | | | |
| Solid content | 40.2% | 39.6% | 40.0% | 40.1% |
| Tg (° C.) | 38.2 | 40.1 | 39.2 | 39.5 |

In Table 1, BA represents butyl acrylate; MAA represents methyl methacrylate; ST represents styrene; AA represents acrylic acid; MAA represents methacrylic acid; DAAM represents diacetone acrylamide; ADH represents adipic acid dihydrazide.

TABLE 2
Composition and properties of aqueous coating material

| | | Examples | | | | Comparative Examples | | | |
|---|---|---|---|---|---|---|---|---|---|
| | | 1 | 2 | 3 | 4 | 1 | 2 | 3 | 4 |
| Acrylic emulsion No. | | 1 | 2 | 1 | 3 | 1 | 2 | 1 | 1 |
| Acrylic emulsion (g) | | 40 | 40 | 40 | 70 | 40 | 40 | 40 | 40 |
| Ink absorbing sphere | | 4 | 4 | 5 | 2 | — | — | — | — |
| containing emulsion (g) | | | | | | | | | |
| Calcium carbonate (g) | | 70 | 70 | 70 | 26 | 70 | 70 | 70 | 70 |
| | Adhesion | ◯ | ◯ | ◯ | ◯ | ◯ | ◯ | ◯ | ◯ |
| | property | | | | | | | | |
| | Scratch | ◯ | ◯ | ◯ | ◯ | ◯ | ◯ | ◯ | ◯ |
| | resistance | | | | | | | | |
| Physical | Alcohol | 95% | 95% | 95% | 95% | 20% | 20% | 20% | 20% |
| properties | resistance | | | | | | | | |
| | Isopropanol | | | | | | | | |
| | resistance | | | | | | | | |
| | Acetone | ◯ | ◯ | ◯ | ◯ | X | X | X | X |
| | resistance | | | | | | | | |
| | Degreasing | ◯ | ◯ | ◯ | ◯ | X | X | X | X |
| | oil resistance | | | | | | | | |
| | Stickiness | ◯ | ◯ | ◯ | ◯ | ◯ | X | X | X |
| | property | | | | | | | | |
| | (water | | | | | | | | |
| | resistance) | | | | | | | | |
| Color | Blue | 0.44 | 0.43 | 0.42 | 0.43 | 0.36 | 0.34 | 0.34 | 0.32 |
| intensity | Red | | | | | | | | |
| | Yellow | | | | | | | | |

| | | | | | | | | |
|---|---|---|---|---|---|---|---|---|
| Evaluation | ◯ | ◯ | ◯ | ◯ | X | X | X | X |

One of the advantages of the present disclosure is that the aqueous coating material for synthetic papers can allow a printed ink pattern to have high color saturation and the effects of clearness and color retention, while providing properties such as high whiteness and brightness, high opacity, and good ink absorbing ability and water resistance, which are required for applications of the synthetic papers. The technical features of “the acrylic emulsion, the hollow latex microspheres and the inorganic ink-absorbing material are added in predetermined amounts, in which each of the hollow latex microspheres has a particle size between 500 nm and 1100 nm and includes a hollow core, a buffering layer covering the hollow core, and a shell covering the buffering layer” can be used to achieve the above-mentioned advantages.

Furthermore, the aqueous coating material of the present disclosure is capable of reducing the emissions of volatile organic compounds (VOCs).

In addition, the monomers of the acrylic emulsion have self-crosslinking ability, such that it does not require additional crosslinking agents and can improve the properties of the surface coating layer, such as adhesion property, cohesive force, hydrophobicity and water and alcohol resistances, and reducing the stickiness of the surface coating layer.

In addition, the present disclosure uses a special three-stage emulsion polymerization method to prepare an emulsion product containing hollow latex microspheres, which has high stability and low foaming properties and is beneficial for quick coating.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated.

Alternative embodiments will become apparent to those skilled in the art to which the present disclosure pertains without departing from its spirit and scope.

What is claimed is:

1. An aqueous coating material for synthetic papers, which is adapted to be formed into a surface coating layer, the aqueous coating material comprising:
26 wt % to 75 wt % of an acrylic emulsion;
2 wt % to 10 wt % of hollow latex microspheres, wherein each of the hollow latex microspheres has a particle size between 500 nm and 1100 nm, and includes a hollow core, a buffering layer covering the hollow core, and a shell covering the buffering layer; and
26 wt % to 70 wt % of an inorganic ink-absorbing material.

2. The aqueous coating material according to claim 1, wherein the acrylic emulsion includes at least one self-crosslinking monomer that is selected from acrylate polymers, hydrophobic (meth)acrylates containing alkyl groups, hydrophobic monomers containing styrene groups, (meth)acrylates containing carboxyl groups, diacetone acrylamide, and adipic acid dihydrazide.

3. The aqueous coating material according to claim 2, wherein glass transition temperatures of the acrylate polymers are between 12° C. to 130° C.

4. The aqueous coating material according to claim 1, wherein the acrylic emulsion includes the following self-crosslinking monomers:
45 wt % to 75 wt % of one or more acrylate polymers;
0.1 wt % to 10 wt % of one or more hydrophobic (meth)acrylates containing alkyl groups;
10 wt % to 45 wt % of one or more hydrophobic monomers containing styrene groups;
1 wt % to 20 wt % of one or more (meth)acrylates containing carboxyl groups;
2 wt % to 10 wt % of diacetone acrylamide; and
2 wt % to 10 wt % of adipic acid dihydrazide.

5. The aqueous coating material according to claim 4, wherein a glass transition temperature of the acrylate polymer is between 12° C. to 130° C.

6. The aqueous coating material according to claim 1, wherein the inorganic ink-absorbing material is in the form of particles having an average particle size between 200 nm and 1500 nm.

7. The aqueous coating material according to claim 6, wherein the inorganic ink-absorbing material is at least one selected from calcium carbonate and barium sulfate.

8. The aqueous coating material according to claim 7, wherein the inorganic ink-absorbing material includes calcium carbonate and barium sulfate in a weight ratio of 1:2.5-5.

9. The aqueous coating material according to claim 1, wherein the surface coating layer has a surface roughness Ra between 0.1 and 1.5.

10. A synthetic paper, comprising:
a synthetic paper substrate; and
a surface coating layer formed on a surface of the synthetic paper substrate, wherein the surface coating layer is formed by the aqueous coating material according to claim 1;
wherein the thickness of the synthetic paper substrate is between 8 μm and 100 μm, and the thickness of the surface coating layer is between 1 μm and 10 μm.
